(19) United States
(12) Patent Application Publication
(10) Pub. No.: US 2023/0307715 A1
(43) Pub. Date: Sep. 28, 2023

(54) SOLID-STATE BATTERY, SOLID-STATE BATTERY MANUFACTURING METHOD, AND SOLID-STATE BATTERY MONITORING METHOD

(71) Applicant: FDK CORPORATION, Tokyo (JP)

(72) Inventors: Masakazu KOBAYASHI, Tokyo (JP); Tomohiro FUJISAWA, Tokyo (JP); Minako SUZUKI, Tokyo (JP); Yuji GOTO, Tokyo (JP)

(73) Assignee: FDK CORPORATION, Tokyo (JP)

(21) Appl. No.: 18/198,325

(22) Filed: May 17, 2023

Related U.S. Application Data
(63) Continuation of application No. PCT/JP2021/035948, filed on Sep. 29, 2021.

(30) Foreign Application Priority Data
Dec. 29, 2020 (JP) 2020-219777

(51) Int. Cl. H01M 10/0585; H01M 10/48; H01M 4/04

(52) U.S. Cl. CPC H01M 10/0585; H01M 4/0471; H01M 10/48

(57) ABSTRACT

A solid-state battery includes a battery body in which a positive electrode layer, an electrolyte layer, and a negative electrode layer are stacked; and a reference electrode stacked on a surface in the direction which these layers are stacked. The solid-state battery further includes a positive electrode connected to the positive electrode layer and a negative electrode connected to the negative electrode layer. The positive and negative electrodes are provided on the battery body.

### CROSS-REFERENCE TO RELATED APPLICATION

This application is a continuation application under 35 U.S.C. 111(a) of International Application PCT/JP2021/035948 filed on Sep. 29, 2021, which designated the U.S., which is based upon and claims the benefit of priority of the prior Japanese Patent Application No. 2020-219777, filed on Dec. 29, 2020, the entire contents of each are incorporated herein by reference.

### FIELD

The embodiment relates to a solid-state battery, a solid-state battery manufacturing method, and a solid-state battery monitoring method.

### BACKGROUND

A solid-state battery in which an electrolyte layer is formed between a positive electrode layer and a negative electrode layer is known. As a solid-state battery, for example, Japanese Laid-open Patent Publication No. 2019-192596 discusses a sulfide solid-state battery including a sulfide solid electrolyte layer having an extended portion. This extended portion covers a peripheral portion of a negative electrode mixture layer disposed on a negative electrode current collector containing copper and extends to be in contact with the negative electrode current collector. A reference electrode is formed on the extended portion. There are cases in which copper is eluted from the negative electrode current collector to the extended portion of the sulfide solid electrolyte layer, and copper sulfide or the like is generated. Japanese Laid-open Patent Publication No. 2019-192596 proposes measuring a voltage drop between the reference electrode and the negative electrode current collector and determining the generation of the copper sulfide or the like at an early stage.

The battery voltage of a solid-state battery indicates the potential difference between a positive electrode connected to a positive electrode layer and a negative electrode connected to a negative electrode layer, these positive and negative electrode layers sandwiching an electrolyte layer. If there is no reference for the voltages of the positive electrode and the negative electrode, there are cases in which the voltages of the positive electrode and the negative electrode could not be evaluated accurately. In these cases, the cause of deterioration or resistive change due to charging or discharging of the solid-state battery could not be determined.

### SUMMARY

In one aspect, there is provide a solid-state battery including: a battery body in which a positive electrode layer, an electrolyte layer, and a negative electrode layer are stacked in a first direction; a reference electrode stacked on a first surface of the battery body in the first direction; a positive electrode provided on the battery body and connected to the positive electrode layer; and a negative electrode provided on the battery body and connected to the negative electrode layer.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWING

FIGS. 1A and 1B illustrate an example of a solid-state battery;

FIGS. 2A and 2B illustrate an example of forming of a positive electrode layer part (part 1);

FIGS. 3A to 3D illustrate an example of forming of a positive electrode layer part (part 2);

FIGS. 4A and 4B illustrate an example of forming of a negative electrode layer part (part 1);

FIGS. 5A to 5D illustrate an example of forming of a negative electrode layer part (part 2);

FIGS. 6A and 6B illustrate an example of forming and cutting of a multi-layer green sheet;

FIGS. 7A and 7B illustrates an example of performing of a thermal process and forming of electrodes;

FIG. 8 illustrates an example of evaluation of an individual solid-state battery;

FIG. 9 illustrates an example of a measurement result of the battery voltage of a solid-state battery during charging and discharging (part 1);

FIG. 10 illustrates an example of measurement results of a positive electrode voltage and a negative electrode voltage obtained by using a reference electrode of the solid-state battery as a reference during charging and discharging and illustrates an example of the difference between the positive and negative electrode voltages (part 1);

FIG. 11 illustrates an example of a comparison result between the battery voltage of the solid-state battery and the difference between the positive electrode voltage and the negative electrode voltage during charging and discharging (part 1);

FIG. 12 illustrates an example of a measurement result of the battery voltage of a solid-state battery during charging and discharging (part 2);

FIG. 13 illustrates an example of measurement results of a positive electrode voltage and a negative electrode voltage obtained by using a reference electrode of the solid-state battery as a reference during charging and discharging and illustrates an example of the difference between the positive and negative electrode voltages (part 2); and

FIG. 14 illustrates an example of a comparison result between the battery voltage of the solid-state battery and the difference between the positive electrode voltage and the negative electrode voltage during charging and discharging (part 2) .

### DESCRIPTION OF EMBODIMENTS

There is known a solid-state battery in which an electrolyte layer containing oxide solid electrolyte or sulfide solid electrolyte is formed between a positive electrode layer containing a positive electrode active material and a negative electrode layer containing a negative electrode active material. For example, it is possible to manufacture the solid-state battery by stacking the positive electrode layer, the negative electrode layer, and the electrolyte layer containing solid electrolyte on top of each other, thermally compressing the stacked multi-layer body, and firing the stacked multi-layer body at once. In the case of a solid-state battery using lithium ion conduction, lithium ions are first conducted during charging from the positive electrode layer to the negative electrode layer via the electrolyte layer and are next captured by the negative electrode layer. In contrast, lithium ions are first conducted during discharging from the negative electrode layer to the positive electrode layer via the electrolyte layer and are next captured by the positive electrode layer. The solid-state battery realizes its charging and discharging operations through this lithium ion conduction. There are some parameters that contribute to the performance of a manufactured solid-state battery. Examples of such parameters of the positive electrode layer and the negative electrode layer include the lithium ion conductivity and the electronic conductivity, and examples of such parameters of the electrolyte layer include the lithium ion conductivity.

The battery voltage of a solid-state battery including an electrolyte layer and a positive electrode layer and a negative electrode layer sandwiching the electrolyte layer indicates the potential difference between a positive electrode connected to the positive electrode layer and a negative electrode connected to the negative electrode layer. If there is no reference for the voltages of the positive electrode and the negative electrode, there are cases in which the voltages of the positive electrode and the negative electrode could not be evaluated accurately. In these cases, the cause of deterioration or resistive change due to charging or discharging of the solid-state battery could not be determined.

Thus, the technique to be described below is used to realize a solid-state battery including a positive electrode and a negative electrode whose voltages are accurately evaluated.

### Solid-State Battery

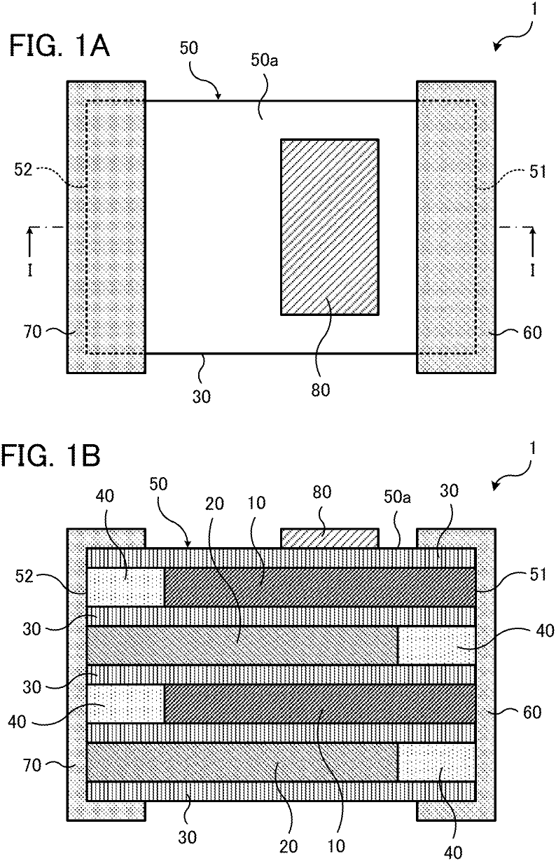

FIGS. 1A and 1B illustrate an example of a solid-state battery. FIG. 1A is a schematic plan view of a main part of an example of a solid-state battery. FIG. 1B is a schematic sectional view of the main part of the example of the solid-state battery. FIG. 1B is a schematic sectional view taken along a line I-I in FIG. 1A.

This solid-state battery 1 illustrated in FIGS. 1A and 1B has a battery body 50 including positive electrode layers 10, negative electrode layers 20, electrolyte layers 30, and embedded layers 40. The solid-state battery 1 further includes a positive electrode 60, a negative electrode 70, and a reference electrode 80, which are formed on the battery body 50.

The individual electrolyte layer 30 contains solid electrolyte. For example, lithium aluminum germanium phosphate Li_{1.5}Al_{0.5}Ge_{1.5} (PO₄)₃ (hereinafter referred to as “LAGP”), which is one kind of NASICON-type oxide solid electrolyte, is used as the solid electrolyte of the electrolyte layer 30. Amorphous LAGP (hereinafter referred to as “LAGPg”) or crystalline LAGP (hereinafter referred to as “LAGPc”) may alternatively be used as the solid electrolyte of the electrolyte layer 30. Still alternatively, both LAGPg and LAGPc may be used.

The individual positive electrode layer 10 contains a positive electrode active material. For example, the positive electrode layer 10 also contains solid electrolyte and conductive auxiliary agent, in addition to the positive electrode active material. For example, lithium cobalt pyrophosphate (Li₂CoP₂O₇, also referred to as “LCPO”) is used as the positive electrode active material of the positive electrode layer 10. Alternatively, lithium cobalt phosphate (LiCoPO₄), lithium vanadium phosphate (Li₃V₂ (PO₄)₃) (also referred to as “LVP”), or the like may be used as the positive electrode active material. One kind of material or two or more kinds of materials may be used as the positive electrode active material of the positive electrode layer 10. For example, LAGP is used as the solid electrolyte of the positive electrode layer 10. For example, a carbon material such as carbon nanofiber, carbon black, graphite, graphene, or carbon nanotube is used as the conductive auxiliary agent of the positive electrode layer 10.

One side end face of the individual positive electrode layer 10 is exposed to the outside from one end face 51 of the battery body 50 (from the end face opposite to an end face 52 from which the individual negative electrode layer 20 is exposed to the outside). Another side end face of the individual positive electrode layer 10 is formed not to be exposed to the outside from the end face 52 of the battery body 50 (from the end face from which the individual negative electrode layer 20 is exposed to the outside). Hereinafter, the end face 51 of the battery body 50, from which the one side end face of the positive electrode layer 10 is exposed to the outside, will also be referred to as “positive electrode terminal face”.

The individual negative electrode layer 20 contains a negative electrode active material. For example, the negative electrode layer 20 contains solid electrolyte and conductive auxiliary agent, in addition to the negative electrode active material. For example, anatase-type titanium oxide (TiO₂) is used as the negative electrode active material of the negative electrode layer 20. Alternatively, one kind of NASICON-type oxide solid electrolyte Li_{1.3}Al_{0.3}Ti_{1.7} (PO₄)₃ (also referred to as “LATP”), LVP, or the like may be used as the negative electrode active material. One kind of material or two or more kinds of materials may be used as the negative electrode active material of the negative electrode layer 20. For example, LAGP is used as the solid electrolyte of the negative electrode layer 20. Alternatively, LAGPg or LAGPc may be used as the solid electrolyte of the negative electrode layer 20. Still alternatively, both LAGPg and LAGPc may be used. For example, a carbon material such as carbon nanofiber, carbon black, graphite, graphene, or carbon nanotube is used as the conductive auxiliary agent of the negative electrode layer 20.

One side end face of the individual negative electrode layer 20 is exposed to the outside from the end face 52 of the battery body 50 (the end face opposite to the end face 51 from which the individual positive electrode layer 10 is exposed to the outside). Another side end face of the individual negative electrode layer 20 is formed not to be exposed to the outside from the end face 51 of the battery body 50 (from the end face from which the positive electrode layer 10 is exposed to the outside). Hereinafter, the end face 52 of the battery body 50, from which the one side end face of the negative electrode layer 20 is exposed to outside, will also be referred to as “negative electrode terminal face”.

For example, the individual embedded layer 40 contains solid electrolyte. For example, LAGP is used as the solid electrolyte of the embedded layer 40. Alternatively, LAGPg or LAGPc may be used as the solid electrolyte of the embedded layer 40. Still alternatively, both LAGPg and LAGPc may be used. Still alternatively, for example, insulating resin or resin containing insulating filler may be used as the embedded layer 40. An embedded layer 40 is formed at an end portion of the individual positive electrode layer 10, the end portion being located opposite to the side end face exposed to the outside from the end face 51 of the battery body 50. An embedded layer 40 is also formed at an end portion of the individual negative electrode layer 20, the end portion being located opposite to the side end face exposed to the outside from the end face 52 of the battery body 50.

The battery body 50 has a structure in which a positive electrode layer 10 and an embedded layer 40 formed at an end thereof and a negative electrode layer 20 and an embedded layer 40 formed at an end thereof are alternately stacked with an electrolyte layer 30 in between, and electrolyte layers 30 are further stacked as the outermost layers. The positive electrode layers 10 (their side end faces) are exposed to the outside from the end face 51 of the battery body 50, and the negative electrode layers 20 (their side end faces) are exposed to the outside from the end face 52 of the battery body 50.

The positive electrode 60 is formed on the end face 51 of the battery body 50 from which the positive electrode layers 10 are exposed to the outside. The positive electrode 60 is in contact with the positive electrode layers 10 exposed to the outside from the end face 51 of the battery body 50 (and with the embedded layers 40 formed at end portions of the negative electrode layers 20) and is electrically connected to the positive electrode layers 10. Various kinds of conductive materials may be used for the positive electrode 60. For example, a material obtained by drying and curing conductive paste may be used.

The negative electrode 70 is formed on the end face 52 of the battery body 50 from which the negative electrode layers 20 are exposed to the outside. The negative electrode 70 is in contact with the negative electrode layers 20 exposed to the outside from the end face 52 of the battery body 50 (and with the embedded layers 40 formed at end portions of the positive electrode layers 10) and is electrically connected to the negative electrode layers 20. Various kinds of conductive materials may be used for the negative electrode 70. For example, a material obtained by drying and curing conductive paste may be used.

The positive electrode 60 and the negative electrode 70 may be made of the same kind of material. Alternatively, the positive electrode 60 may be made of a material different from that of the negative electrode 70.

The reference electrode 80 is formed on a surface of the battery body 50. For example, the reference electrode 80 is formed on a surface 50a of the battery body 50 in the direction in which the positive electrode layers 10, the electrolyte layers 30, and the negative electrode layers 20 are stacked. The reference electrode 80 is formed closer to one of the positive electrode 60 (located in the direction of the end face 51 from which the positive electrode layers 10 are exposed) and the negative electrode 70 (located in the direction of the end face 52 from which the negative electrode layers 20 are exposed) on the surface 50a of the battery body 50 than the other one of the positive electrode 60 and the negative electrode 70. In FIG. 1B, the reference electrode 80 is formed closer to the positive electrode 60 than the negative electrode 70. In this way, it is possible to use the reference electrode 80 as a marker indicating a polarity of the solid-state battery 1 (indicating the positive electrode side or the negative electrode side).

Various kinds of conductive materials may be used for the reference electrode 80. For example, a positive electrode material used for the positive electrode layers 10 may be used for the reference electrode 80. For example, a material containing a positive electrode active material, solid electrolyte, conductive auxiliary agent, etc., may be used. Alternatively, a conductive material containing solid electrolyte and conductive auxiliary agent may be used for the reference electrode 80. In addition, a negative electrode material used for the negative electrode layers 20 may be used for the reference electrode 80. For example, a negative electrode material containing a negative electrode active material, solid electrolyte, and conductive auxiliary agent may be used. If the positive electrode material, conductive material, or negative electrode material as described above is used for the reference electrode 80, it is possible to integrally sinter the reference electrode 80 and the battery body 50 at once through a thermal process (degreasing and firing) performed in the manufacture of the solid-state battery 1.

With the solid-state battery 1 having the structure as described above, it is possible to measure the voltage of the positive electrode 60 and the voltage of the negative electrode 70 by using the reference electrode 80 formed on the surface 50a of battery body 50 as a reference. Hereinafter, the voltage of the positive electrode 60 will also be referred to as “positive electrode voltage” and the voltage of the negative electrode 70 as “negative electrode voltage”.

Each of the positive electrode voltage and the negative electrode voltage of the solid-state battery 1 fluctuates due to charging or discharging, and the difference between the positive electrode voltage and the negative electrode voltage matches the battery voltage. However, when deterioration or resistive change occurs in the solid-state battery 1, it is difficult to determine whether the deterioration or resistive change is due to the positive electrode side (the positive electrode layers 10, for example) or the negative electrode side (the negative electrode layers 20, for example) by using only the battery voltage. If this determination is performed accurately, it will be useful, for example, in determining the cause of a defect of the solid-state battery 1 when the solid-state battery 1 is inspected, manufactured, or actually used, in addition to in developing the solid-state battery 1.

Thus, the reference electrode 80 is formed on the surface 50a of the battery body 50 of the solid-state battery 1. In this way, it is possible to measure and monitor the positive electrode voltage and the negative electrode voltage by using the reference electrode 80. By measuring the voltage of each of the positive electrode 60 and negative electrode 70, that is, each of the positive electrode voltage and the negative electrode voltage, by using the reference electrode 80 as a reference, it is possible to monitor and check the behaviors of the positive electrode voltage and the negative electrode voltage and accurately evaluate each of the positive electrode voltage and the negative electrode voltage. As a result, it is possible to accurately determine the cause of deterioration or resistive change of the solid-state battery 1.

In addition, a marker indicating a polarity of the solid-state battery 1 may be configured to also function as the reference electrode 80 as described above. If the reference electrode 80 for accurately evaluating the voltage of each of the positive electrode 60 and the negative electrode 70 is formed in addition to a marker indicating a polarity of the solid-state battery 1, increase in size of the solid-state battery 1, increase in complexity of the manufacturing process, and increase in cost which may be caused. However, by having a marker also function as the reference electrode 80, the above increases are prevented.

### Solid-State Battery Manufacturing Method

Next, a manufacturing method of the solid-state battery 1 having the structure as described above will be described in detail based on specific examples.

First, examples of forming of an electrolyte sheet, positive electrode layer paste, negative electrode layer paste, embedded layer paste, and reference electrode paste will be described.

### (Forming of Electrolyte Sheet)

Paste containing solid electrolyte, binder, plasticizer, dispersant, and diluent is used to form an electrolyte sheet. For example, this electrolyte sheet paste to be used contains 29.0 wt% (weight percent) LAGPg and 3.2 wt% LAGPc as the solid electrolyte, 6.5 wt% polyvinyl butyral (PVB) as the binder, 2.2 wt% plasticizer, 0.3 wt% first dispersant, 16.1 wt% second dispersant, and 43.4 wt% ethanol as the diluent. One kind of material or two or more kinds of materials may be used for each of the binder, plasticizer, dispersant, and diluent of the electrolyte sheet paste.

The component materials of the electrolyte sheet paste as described above are mixed and dispersed, for example, for 48 hours in a ball mill, to form the electrolyte sheet paste. The formed electrolyte sheet paste is coated and dried. For example, the formed electrolyte sheet paste is applied by using a sheet forming apparatus such as a doctor blade and is dried for 10 minutes at 100° C., to form the electrolyte sheet.

### (Forming of Positive Electrode Layer Paste)

Positive electrode layer paste to be used contains a positive electrode active material, solid electrolyte, conductive auxiliary agent, binder, plasticizer, dispersant, and diluent. For example, the positive electrode layer paste contains 11.8 wt% LCPO as the positive electrode active material, 17.7 wt% LAGPg as the solid electrolyte, 2.7 wt% carbon nanofiber as the conductive auxiliary agent, 7.9 wt% PVB as the binder, 0.3 wt% plasticizer, 0.6 wt% first dispersant, and 59.1 wt% terpineol as the diluent. One kind of material or two or more kinds of materials may be used for each of the binder, plasticizer, dispersant, and diluent of the positive electrode layer paste.

For example, the component materials of the positive electrode layer paste as described above are mixed and dispersed by a ball mill for 72 hours and by a triple roll mill until a grind gauge indicates that the individual aggregate becomes 1 µm or less. In this way, the positive electrode layer paste is formed.

### (Forming of Negative Electrode Layer Paste)

The negative electrode layer paste to be used contains a negative electrode active material, solid electrolyte, conductive auxiliary agent, binder, plasticizer, dispersant, and diluent. For example, the negative electrode layer paste contains 11.8 wt% anatase-type TiO₂ as the negative electrode active material, 17.7 wt% LAGPg as the solid electrolyte, 2.7 wt% carbon nanofiber as the conductive auxiliary agent, 7.9 wt% PVB as the binder, 0.3 wt% of plasticizer, 0.6 wt% first dispersant, and 59.1 wt% terpineol as the diluent. One kind of material or two or more kinds of materials may be used for each of the binder, plasticizer, dispersant, and diluent of the negative electrode layer paste.

For example, the component materials of the negative electrode layer paste as described above are mixed and dispersed by a ball mill for 72 hours and by a triple roll mill until a grind gauge indicates that the individual aggregate becomes 1 µm or less. In this way, the negative electrode layer paste is formed.

### (Forming of Embedded Layer Paste)

Paste containing solid electrolyte, binder, plasticizer, dispersant, and diluent is used as the embedded layer paste. For example, the embedded layer paste to be used contains 25.4 wt% LAGPg and 2.8 wt% LAGPc as the solid electrolyte, 8.5 wt% PVB as the binder, 0.2 wt% plasticizer, 1.9 wt% first dispersant, and 61.2 wt% terpineol as the diluent. One kind of material or two or more kinds of materials may be used for each of the binder, plasticizer, dispersant, and diluent of the embedded layer paste.

For example, the component materials of the embedded layer paste as described above are mixed and dispersed by a ball mill for 72 hours and by a triple roll mill until a grind gauge indicates that the individual aggregate becomes 1 µmor less. In this way, the embedded layer paste is formed.

### (Forming of Reference Electrode Paste)

For example, the reference electrode paste to be used contains a positive electrode active material, solid electrolyte, conductive auxiliary agent, binder, plasticizer, dispersant, and diluent. For example, the positive electrode layer paste as described above is used as the reference electrode paste. That is, the positive electrode layer paste containing 11.8 wt% LCPO as the positive electrode active material, 17.7 wt% LAGPg as the solid electrolyte, 2.7 wt% carbon nanofiber as the conductive auxiliary agent, 7.9 wt% PVB as the binder, 0.3 wt% plasticizer, 0.6 wt% first dispersant, and 59.1 wt% terpineol as the diluent is used as the reference electrode paste. Hereinafter, the reference electrode paste, for which the positive electrode layer paste containing a positive electrode material as described above is used, will also be referred to as “reference electrode paste containing a positive electrode material”. One kind of material or two or more kinds of materials may be used for each of the binder, plasticizer, dispersant, and diluent of the reference electrode paste containing the positive electrode material. Predetermined component materials are mixed and dispersed, to form the reference electrode paste containing a positive electrode material.

In addition, as another kind of reference electrode paste, for example, paste containing solid electrolyte, conductive auxiliary agent, binder, plasticizer, dispersant, and diluent is used. For example, paste containing 26.8 wt% LAGPg as the solid electrolyte, 1.4 wt% carbon nanofiber as the conductive auxiliary agent, 8.5 wt% PVB as the binder, 0.2 wt% plasticizer, 1.9 wt% first dispersant, and 61.2 wt% terpineol as the diluent is used as the reference electrode paste. Hereinafter, as described above, the reference electrode paste, for which the paste that contains carbon nanofiber as the conductive auxiliary agent and that does not contain an active material such as a positive electrode active material is used, will also be referred to as “reference electrode paste containing a carbon material”. One kind of material or two or more kinds of materials may be used for each of the binder, plasticizer, dispersant, and diluent of the reference electrode paste containing a carbon material. Predetermined component materials are mixed and dispersed, to form the reference electrode paste containing a carbon material.

In addition, as still another kind of reference electrode paste, for example, paste containing a negative electrode active material, solid electrolyte, conductive auxiliary agent, binder, plasticizer, dispersant, and diluent may be used. For example, the negative electrode layer paste as described above is used as the reference electrode paste. Hereinafter, the reference electrode paste, for which the negative electrode layer paste containing a negative electrode material as described above is used, will also be referred to as “reference electrode paste containing a negative electrode material”.

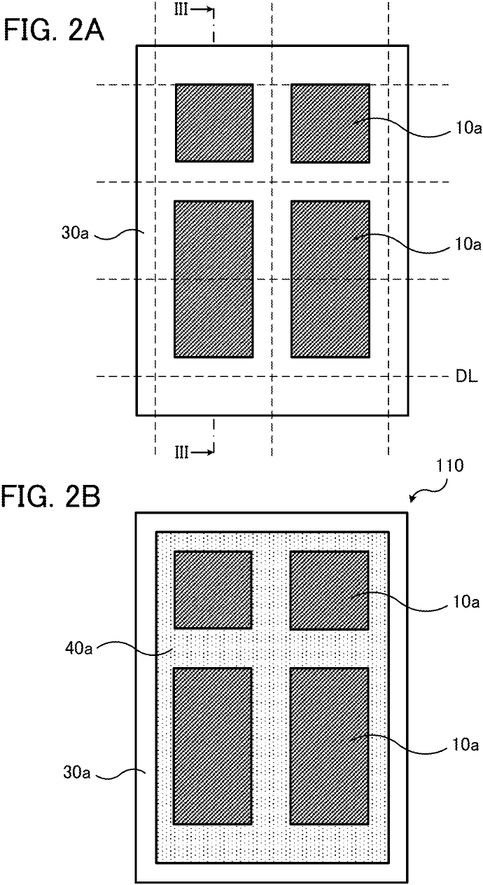

Next, an example of the manufacture of a solid-state battery using the electrolyte sheet, positive electrode layer paste, negative electrode layer paste, embedded layer paste, and reference electrode paste prepared as described above will be described with reference to FIGS. 2A to 7B.

### (Forming of Positive Electrode Layer Part)

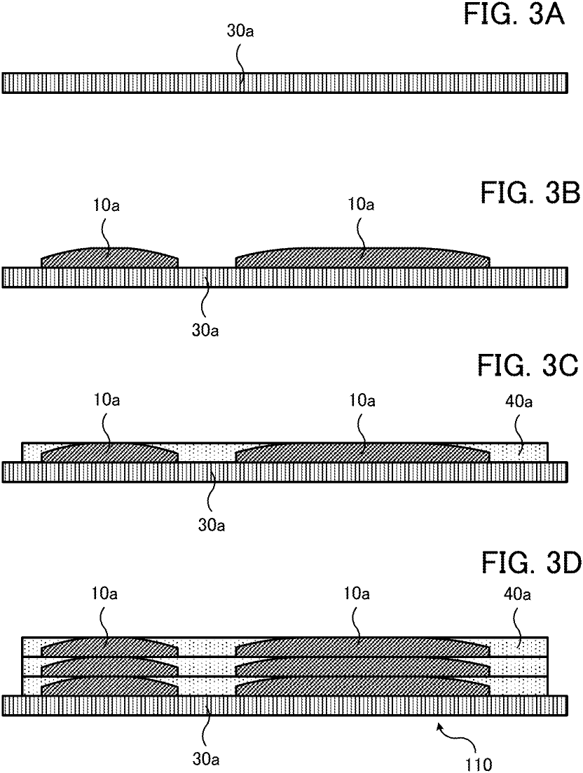

FIGS. 2A and 2B and FIGS. 3A to 3D illustrate an example of forming of a positive electrode layer part. FIG. 2A is a schematic plan view of a main part of an example of a positive electrode layer forming process. FIG. 2B is a schematic plan view of a main part of an example of an embedded layer forming process. FIGS. 3A to 3D are each a schematic sectional view of a main part of an example of a positive electrode layer part forming process. FIGS. 3A to 3D are each a schematic sectional view taken along a line III-III in FIG. 2A.

As illustrated in FIG. 2A, positive electrode layers 10a are formed by coating an electrolyte sheet 30a with positive electrode layer paste and by drying the applied positive electrode layer paste. The electrolyte sheet 30a is coated with the positive electrode layer paste by performing screen printing, for example. The applied positive electrode layer paste is dried at 90° C. for 5 minutes, for example.

The positive electrode layers 10a are formed in a plurality of areas on a single electrolyte sheet 30a. A plurality of solid-state batteries 1 are to be formed in their respective areas. For example, two different sizes, large and small sizes, of positive electrode layers 10a are illustrated in FIG. 2A. Each of the positive electrode layers 10a of the small size is used for a single solid-state battery 1, and each of the positive electrode layers 10a of the large size is used for two solid-state batteries 1. In FIG. 2A, for convenience, locations DL used when a multi-layer green sheet is cut into a plurality of solid-state batteries 1 as will be described below are illustrated by dashed lines.

After the positive electrode layers 10a are formed, an embedded layer 40a is formed by coating the peripheral area around the individual positive electrode layer 10a on the electrolyte sheet 30a with embedded layer paste and by drying the applied embedded layer paste, as illustrated in FIG. 2B. The peripheral area is coated with the embedded layer paste by performing screen printing, for example. The applied embedded layer paste is dried at 90° C. for 5 minutes, for example.

The processes as illustrated in FIGS. 2A and 2B are repeated until a predetermined number of layers are formed, for example, until a single positive electrode layer part 110 is formed. This positive electrode layer part 110 has a number of layers satisfying a sufficient active material amount and thickness needed for this positive electrode layer part 110 to function as a positive electrode layer 10 of the solid-state battery 1. A single positive electrode layer part 110 may be formed by forming the positive electrode layers 10a and the embedded layer 40a in only one layer as illustrated in FIGS. 2A and 2B.

The following example will be described with reference to FIGS. 3A to 3D. In this example, a positive electrode layer part 110 is formed by repeating the forming of positive electrode layers 10a and an embedded layer 40a until three layers are formed.

In this case, first, an electrolyte sheet 30a is prepared as illustrated in FIG. 3A.

Next, as illustrated in FIG. 3B, positive electrode layers 10a in the first layer are formed by coating predetermined areas on the electrolyte sheet 30a (areas where a plurality of solid-state batteries 1 are to be formed) with positive electrode layer paste through screen printing and by drying the applied positive electrode layer paste. When formed in a corresponding one of the areas on the electrolyte sheet 30a by performing screen printing, the individual positive electrode layer 10a in the first layer is formed such that its inner portion is thicker than its outer edge portion.

Next, as illustrated in FIG. 3C, an embedded layer 40a in the first layer is formed by coating the peripheral area of the individual positive electrode layer 10a in the first layer on the electrolyte sheet 30a with embedded layer paste through screen printing and by drying the applied embedded layer paste. The embedded layer 40a in the first layer is formed such that the edge portion of the individual positive electrode layer 10a in the first layer is coated with the embedded layer 40a, the edge portion being thinner than the inner portion of this positive electrode layer 10a, and such that the inner portion thinker than the edge portion is exposed to the outside.

Next, as illustrated in FIG. 3D, the positive electrode layers 10a in the second layer are formed on the positive electrode layers 10a in the first layer by coating the positive electrode layers 10a in the first layer with the positive electrode layer paste through screen printing and by drying the applied positive electrode layer paste. As is the case with the positive electrode layers 10a in the first layer, the positive electrode layers 10a in the second layer are formed such that the inner portion of the individual positive electrode layer 10a is thicker than the outer edge portion thereof. Part of the embedded layer 40a in the first layer is formed between the edge portion of the individual positive electrode layer 10a in the first layer and the edge portion of the individual positive electrode layer 10a in the second layer such that the part covers the edge portion of the individual positive electrode layer 10a in the first layer. Next, the embedded layer 40a in the second layer is formed by coating the peripheral area of the individual positive electrode layer 10a in the second layer with embedded layer paste through screen printing and by drying the applied embedded layer paste. The embedded layer 40a in the second layer is formed such that the edge portion of the individual positive electrode layer 10a in the second layer is coated with the embedded layer 40a and such that the inner portion of the individual positive electrode layer 10a is exposed to the outside. The positive electrode layers 10a and the embedded layer 40a in the third layer are formed in the same way as the positive electrode layers 10a and the embedded layer 40a in the second layer. As a result, the structure as illustrated in FIG. 3D is obtained.

For example, by performing the processes as illustrated in FIGS. 3A to 3D, a positive electrode layer part 110 having a structure in which the positive electrode layers 10a are stacked in three layers and the edge portions thereof are coated with their respective embedded layers 40a is formed.

### (Forming of Negative Electrode Layer Part)

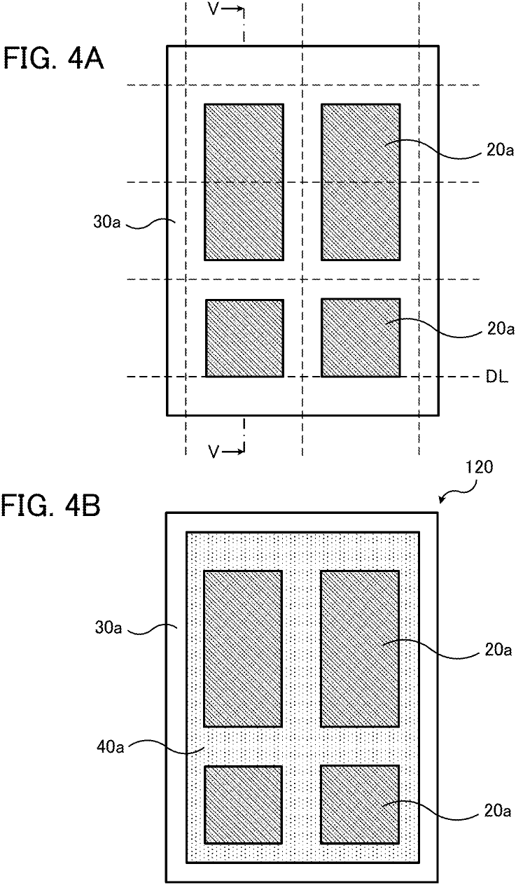

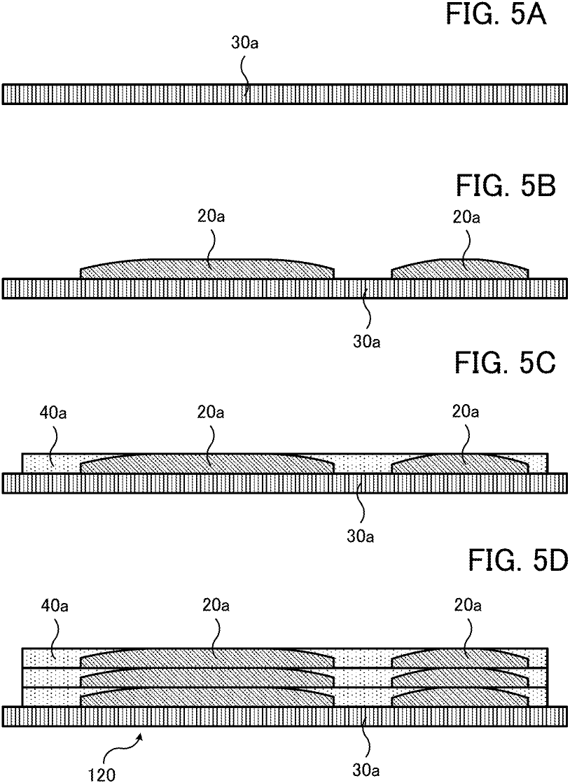

FIGS. 4A and 4B and FIGS. 5A to 5D illustrate an example of forming of a negative electrode layer part. FIG. 4A is a schematic plan view of a main part of an example of a negative electrode layer forming process. FIG. 4B is a schematic plan view of a main part of an example of an embedded layer forming process. FIGS. 5A to 5D are each a schematic sectional view of a main part of an example of a negative electrode layer part forming process. FIGS. 5A to 5D are each a schematic sectional view taken along a line V-V in FIG. 4A.

As illustrated in FIG. 4A, negative electrode layers 20a are formed by coating an electrolyte sheet 30a with negative electrode layer paste and by drying the applied negative electrode layer paste. The electrolyte sheet 30a is coated with the negative electrode layer paste by performing screen printing, for example. The applied negative electrode layer paste is dried at 90° C. for 5 minutes, for example.

The negative electrode layers 20a are formed in a plurality of areas on a single electrolyte sheet 30a. A plurality of solid-state batteries 1 are to be formed in their respective areas. For example, two different sizes, large and small sizes, of negative electrode layers 20a are illustrated in FIG. 4A. Each of the negative electrode layers 20a of the small size is used for a single solid-state battery 1, and each of the negative electrode layers 20a of the large size is used for two solid-state batteries 1. In FIG. 4A, for convenience, locations DL used when a multi-layer green sheet is cut into a plurality of solid-state batteries 1 as will be described below are illustrated by dashed lines.

After the negative electrode layers 20a are formed, an embedded layer 40a is formed by coating the peripheral area around the individual negative electrode layer 20a on the electrolyte sheet 30a with embedded layer paste and by drying the applied embedded layer paste, as illustrated in FIG. 4B. The peripheral area is coated with the embedded layer paste by performing screen printing, for example. The applied embedded layer paste is dried at 90° C. for 5 minutes, for example.

The processes as illustrated in FIGS. 4A and 4B are repeated until a predetermined number of layers are formed, for example, until a single negative electrode layer part 120 is formed. This negative electrode layer part 120 has a number of layers satisfying a sufficient active material amount and thickness needed for this negative electrode layer part 120 to function as a negative electrode layer 20 of the solid-state battery 1. A single negative electrode layer part 120 may be formed by forming the negative electrode layers 20a and the embedded layer 40a in only one layer as illustrated in FIGS. 4A and 4B.

The following example will be described with reference to FIGS. 5A to 5D. In this example, a negative electrode layer part 120 is formed by repeating the forming of negative electrode layers 20a and an embedded layer 40a until three layers are formed.

In this case, first, an electrolyte sheet 30a is prepared as illustrated in FIG. 5A.

Next, as illustrated in FIG. 5B, negative electrode layers 20a in the first layer are formed by coating predetermined areas on the electrolyte sheet 30a (areas where a plurality of solid-state batteries 1 are formed) with negative electrode layer paste through screen printing and by drying the applied negative electrode layer paste. When formed in a corresponding one of the areas on the electrolyte sheet 30a by performing screen printing, the individual negative electrode layer 20a in the first layer is formed such that its inner portion is thicker than its outer edge portion.

Next, as illustrated in FIG. 5C, an embedded layer 40a in the first layer is formed by coating the peripheral area of the individual negative electrode layer 20a in the first layer on the electrolyte sheet 30a with embedded layer paste through screen printing and by drying the applied embedded layer paste. The embedded layer 40a in the first layer is formed such that the edge portion of the individual negative electrode layer 20a in the first layer is coated with the embedded layer 40a, the edge portion being thinner than the inner portion of this negative electrode layer 20a, and such that the inner portion thinker than the edge portion is exposed to the outside.

Next, as illustrated in FIG. 5D, the negative electrode layers 20a in the second layer are formed on the negative electrode layers 20a in the first layer by coating the negative electrode layers 20a in the first layer with the negative electrode layer paste through screen printing and by drying the applied negative electrode layer paste. As is the case with the negative electrode layers 20a in the first layer, the negative electrode layers 20a in the second layer are formed such that the inner portion of the individual negative electrode layer 20a is thicker than the outer edge portion thereof. Part of the embedded layer 40a in the first layer is formed between the edge portion of the individual negative electrode layer 20a in the first layer and the edge portion of the individual negative electrode layer 20a in the second layer such that the part covers the edge portion of the individual negative electrode layer 10a in the first layer. Next, the embedded layer 40a in the second layer is formed by coating the peripheral area of the individual negative electrode layer 20a in the second layer with embedded layer paste through screen printing and by drying the applied embedded layer paste. The embedded layer 40a in the second layer is formed such that the edge portion of the individual negative electrode layer 20a in the second layer is coated with the embedded layer 40a and such that the inner portion of the individual negative electrode layer 20a is exposed to the outside. The negative electrode layers 20a and the embedded layer 40a in the third layer are formed in the same way as the negative electrode layers 20a and the embedded layer 40a in the second layer. As a result, the structure as illustrated in FIG. 5D is obtained.

For example, by performing the processes as illustrated in FIGS. 5A to 5D, a negative electrode layer part 120 having a structure in which the negative electrode layers 20a are stacked in three layers and the edge portions thereof are coated with their respective embedded layers 40a is formed.

### (Forming and Cutting of Multi-layer Green Sheet)

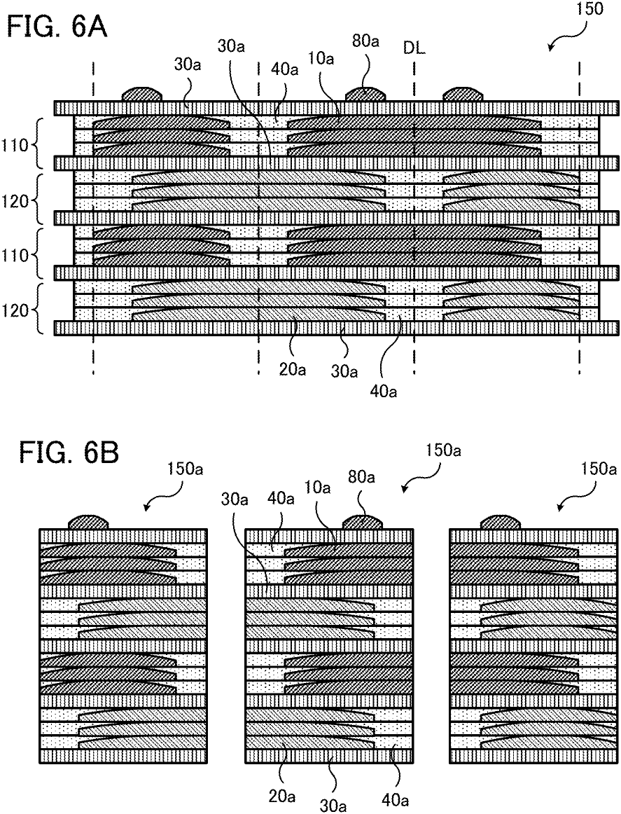

FIGS. 6A and 6B illustrate an example of forming and cutting of a multi-layer green sheet. FIG. 6A is a schematic sectional view of a main part of an example of a multi-layer green sheet forming process. FIG. 6B is a schematic sectional view of a main part of an example of a multi-layer green sheet cutting process.

The basic structure of a multi-layer green sheet is formed by alternately stacking positive electrode layer parts 110 and negative electrode layer parts 120 obtained as described above and by performing thermal compression on the stack parts. For example, as illustrated in FIG. 6A, a positive electrode layer part 110 in the first layer is stacked on a negative electrode layer part 120 in the first layer. Next, a negative electrode layer part 120 in the second layer is stacked on the positive electrode layer part 110 in the first layer, and a positive electrode layer part 110 in the second layer is stacked on the negative electrode layer part 120 in the second layer. An electrolyte sheet 30a is stacked in the topmost layer. For example, these stacked parts are thermally compressed with 20 MPa at 45° C., and as a result, the basic structure of a multi-layer green sheet is formed.

When the basic structure of a multi-layer green sheet is formed as described above, the negative electrode layer parts 120 and the positive electrode layer parts 110 are stacked on top of each other such that an individual negative electrode layer 20a and an individual positive electrode layer 10a that face each other partly overlap with each other in the sectional view in FIG. 6A. That is, the negative electrode layer parts 120 and the positive electrode layer parts 110 are stacked on top of each other such that a positive electrode layer 10a is located over its neighboring negative electrode layers 20a and such that a negative electrode layer 20a is located over its neighboring positive electrode layers 10a. Alternatively, screen printing is performed such that the negative electrode layers 20a and the positive electrode layers 10a partly overlap with each other in the sectional view in FIG. 6A when the negative electrode layer parts 120 and the positive electrode layer parts 110 are stacked on top of each other in the their respective forming processes.

In addition, the negative electrode layer parts 120 and the positive electrode layer parts 110 are stacked on top of each other such that the negative electrode layers 20a and the positive electrode layers 10a entirely overlap with each other in a sectional view perpendicular to the sectional view illustrated in FIG. 6A. Alternatively, screen printing is performed such that the negative electrode layers 20a and the positive electrode layers 10a entirely overlap with each other in a sectional view perpendicular to the sectional view illustrated in FIG. 6 when the negative electrode layer parts 120 and the positive electrode layer parts 110 are stacked on top of each other in their respective forming processes.

Next, reference electrode paste is formed on the basic structure of the multi-layer green sheet. Examples of the reference electrode paste includes the reference electrode paste containing a positive electrode material and the reference electrode paste containing a carbon material as described above. Reference electrode layers 80a are formed by coating the basic structure of the multi-layer green sheet with predetermined reference electrode paste through screen printing and by drying the reference electrode paste under predetermined conditions, such as at 90° C. for 5 minutes, for example.

The reference electrode layers 80a may be formed by performing coating once or a plurality of times to achieve a predetermined thickness. If the reference electrode layers 80a are formed by performing coating a plurality of times, the reference electrode layers 80a may be dried each time the coating is performed or may be dried at once after the coating is performed the plurality of times.

The individual reference electrode layer 80a is formed to have a function as a marker that indicates a polarity (positive or negative) of the corresponding solid-state battery 1 manufactured. For example, the individual reference electrode layer 80a is formed at a location that indicates the positive electrode side of the corresponding solid-state battery 1 when a multi-layer green sheet 150 is cut into a plurality of solid-state batteries 1 as will be described below.

The formed reference electrode layers 80a are thermally compressed on the basic structure of the multi-layer green sheet under the conditions, such as with 20 MPa and at 45° C., for example. As a result, the multi-layer green sheet 150 in which the positive electrode layer parts 110 and the negative electrode layer parts 120 are alternately stacked on top of each other and the reference electrode layers 80a are formed at predetermined locations on the electrolyte sheet 30a in the topmost layer is formed.

The formed multi-layer green sheet 150 is cut by a cutter at the locations DL as indicated by dashed lines in FIG. 6A (corresponding to the locations DL indicated by the dashed lines in FIGS. 2A and 4A). As a result, as illustrated in FIG. 6B, a plurality of pieces 150a are formed out of the multi-layer green sheet 150. In the case of the individual piece 150a formed by cutting the multi-layer green sheet 150, side end faces of the positive electrode layers 10a in three layers are exposed to one cut surface, and side end faces of the negative electrode layers 20a in three layers are exposed to the other cut surface. Alternatively, the locations DL may be set such that side end faces of the positive electrode layers 10a in three layers are exposed to one cut surface and such that side end faces of the negative electrode layers 20a in three layers are exposed to the other cut surface. In this case, the multi-layer green sheet 150 is cut at these locations DL, to form a plurality of pieces 150a.

### (Performing Thermal Process and Forming Electrodes)

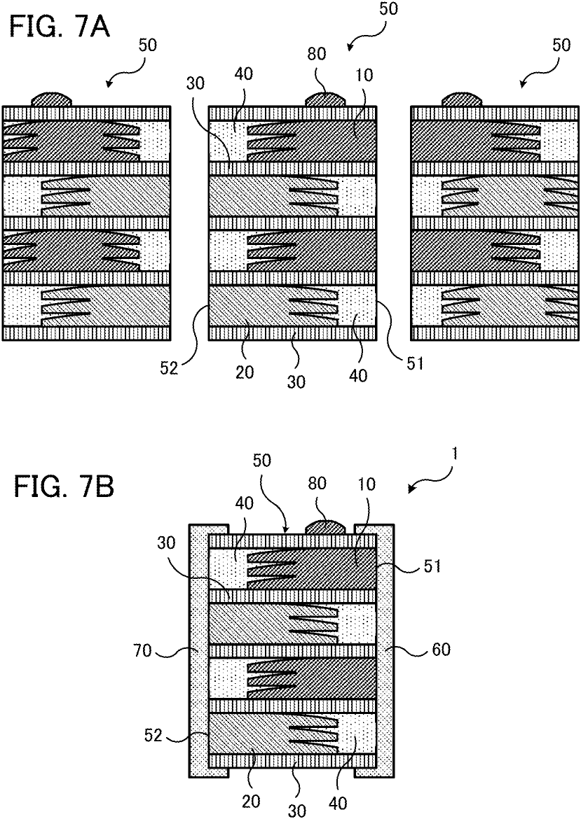

FIGS. 7A and 7B illustrate an example of performing a thermal process and forming electrodes. FIG. 7A is a schematic sectional view of a main part of an example of a thermal process. FIG. 7B is a schematic sectional view of a main part of an example of an electrode forming process.

After the multi-layer green sheet 150 is cut, a thermal process for degreasing and firing is performed on the plurality of pieces 150a formed. In the thermal process, the degreasing is performed under the conditions that the plurality of pieces 150a is held in an atmosphere containing oxygen at 500° C. for 10 hours. In the thermal process, sintering is performed under the conditions that the plurality of pieces 150a is held in an atmosphere containing nitrogen at 600° C. for 2 hours. Through this thermal process, individual battery bodies 50 as illustrated in FIG. 7A are formed.

In the individual battery body 50, the cut electrolyte sheets 30a are sintered, and as a result electrolyte layers 30 are formed. In the individual battery body 50, the positive electrode layers 10a in three layers stacked in each of the cut positive electrode layer parts 110 are sintered, and as a result, positive electrode layers 10, each of which is a unified layer, are formed. In the individual battery body 50, the negative electrode layers 20a in three layers stacked in each of the cut negative electrode layer parts 120 are sintered, and as a result, negative electrode layers 20, each of which is a unified layer, are formed. In the individual battery body 50, the embedded layers 40a in three layers stacked in each of the cut negative electrode layer parts 120 and positive electrode layer parts 110 are sintered, and as a result, embedded layers 40, each of which is a unified layer, are formed. On the surface 50a of the individual battery body 50, a reference electrode layer 80a in one layer is sintered or reference electrode layers 80a in a plurality of layers are sintered and unified. As a result, a reference electrode 80 is formed.

Each battery body 50 formed by the thermal process includes a plurality of battery cells, each of which is formed by a positive electrode layer 10, a negative electrode layer 20, and an electrolyte layer 30 therebetween.

As illustrated in FIG. 7A, side end faces of the positive electrode layers 10 of an individual battery body 50 are exposed to one end face 51 of this battery body 50, and side end faces of the negative electrode layers 20 of the battery body 50 are exposed to the other end face 52 of the battery body 50. That is, the end face 51 of an individual battery body 50 functions as the positive electrode terminal face, and the end face 52 functions as the negative electrode terminal face. In addition, as illustrated in FIG. 7B, a positive electrode 60 is formed on the end face 51 of the battery body 50, the end face 51 functioning as the positive electrode terminal face, and a negative electrode 70 is formed on the end face 52 functioning as the negative electrode terminal face. FIG. 7B illustrates one of the battery bodies 50 obtained by the above cutting and thermal process, the positive electrode 60 having been formed on the end face 51, and the negative electrode 70 having been formed on the end face 52.

Various kinds of conductive materials are used for the positive electrode 60 and the negative electrode 70 of the individual solid-state battery 1. For example, a material obtained by drying and curing a conductive material containing at least one kind of metal materials such as silver (Ag), platinum (Pt), palladium (Pd), gold (Au), and copper (Cu) may be used for the positive electrode 60 and the negative electrode 70. For example, conductive paste may be formed by a dip method or the like on an individual end portion of the end face 51 of the battery body 50 to which the positive electrode layers 10 are exposed and an individual end portion of the end face 52 to which the negative electrode layers 20 are exposed. Next, the conductive paste may be dried and cured at 120° C. for 30 minutes. As a result, the positive electrode 60 and the negative electrode 70 are formed.

Various kinds of conductive materials such as conductive paste or solder may be used for the individual reference electrode 80, and a conductive wire or a terminal may be connected to the individual reference electrode 80.

The individual solid-state battery 1 is formed by the method as described above.

With the individual solid-state battery 1, it is possible to measure and monitor the voltage of the positive electrode 60 and the voltage of the negative electrode 70 by using the reference electrode 80 formed on the surface 50a of the battery body 50 as a reference. In addition, with the solid-state battery 1, the reference electrode 80 may be used not only as the reference for the voltages of the positive electrode 60 and the negative electrode 70 but also as a marker that indicates a polarity of the solid-state battery 1.

### Evaluation of Solid-State Battery

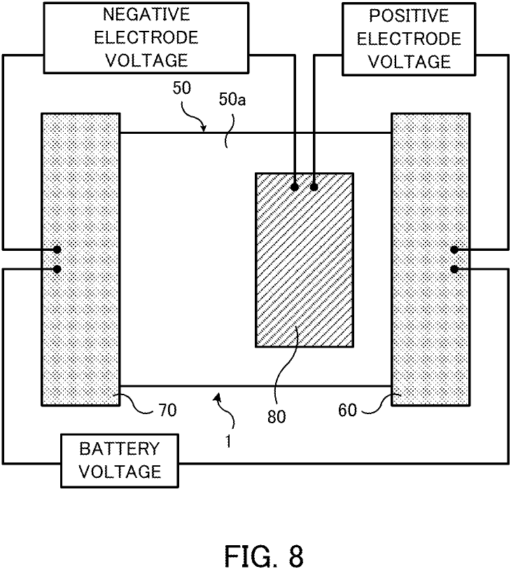

FIG. 8 illustrates an example of evaluation of an individual solid-state battery.

First, an individual solid-state battery 1 formed as described above was repeatedly charged and discharged, and next, the battery voltage, the positive electrode voltage, and the negative electrode voltage were evaluated. The charging and discharging of the solid-state battery 1 was conducted based on constant-current (CC) charging and CC discharging in three cycles in an environment in which the current value was 25 µA/cm², the charging upper limit voltage was 3.6 V, and the discharging lower limit voltage was 0 V at 20° C. During the charging and discharging of the solid-state battery 1, the potential difference between the positive electrode 60 and the negative electrode 70 was measured as the battery voltage. During the charging and discharging of the solid-state battery 1, the voltage of the positive electrode 60 was measured as the positive electrode voltage by using the reference electrode 80 as a reference (measured with respect to the reference electrode 80). In addition, during the charging and discharging of the solid-state battery 1, the voltage of the negative electrode 70 was measured as the negative electrode voltage by using the reference electrode 80 as a reference (measured with respect to the reference electrode 80).

Two kinds of solid-state batteries 1 were used. One solid-state battery 1 includes a reference electrode 80 formed by using the reference electrode paste containing a positive electrode material, and the other solid-state battery 1 includes a reference electrode 80 formed by using the reference electrode paste containing a carbon material. Hereinafter, evaluation on the solid-state battery 1 including the reference electrode 80 formed by using the reference electrode paste containing a positive electrode material will be described as a first evaluation example, and evaluation on the solid-state battery 1 including the reference electrode 80 formed by using the reference electrode paste containing a carbon material will be described as a second evaluation example.

### (First Evaluation Example)

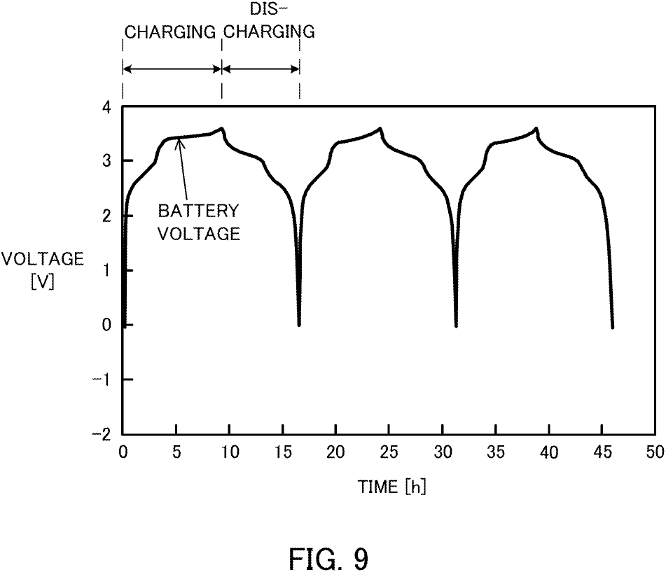

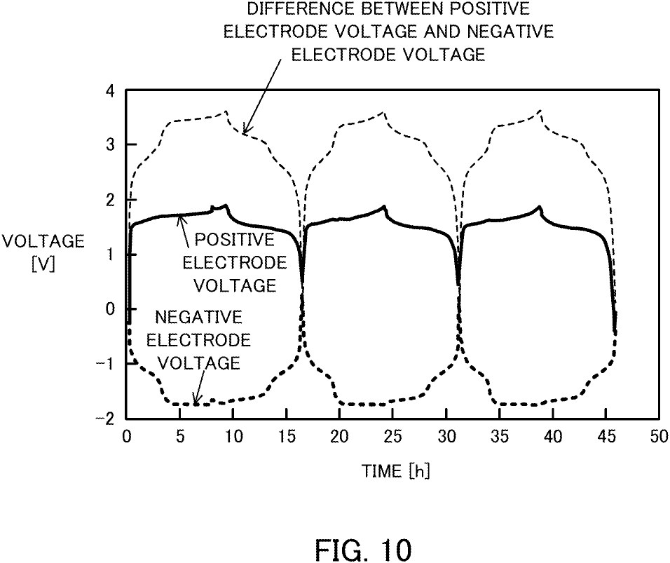

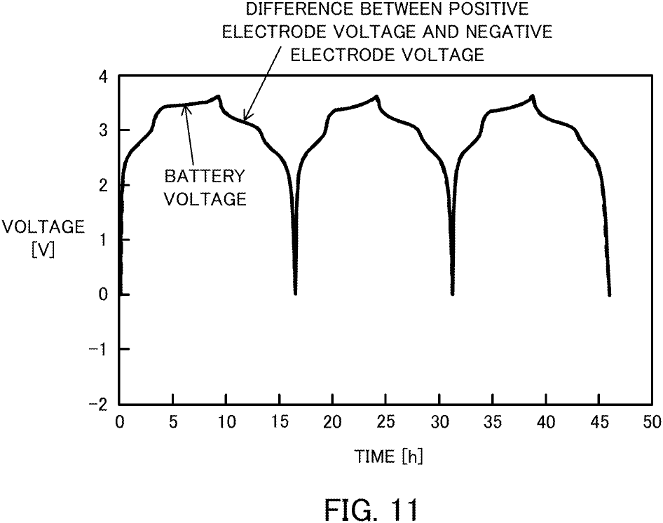

FIG. 9 illustrates an example of a measurement result of the battery voltage of a solid-state battery during charging and discharging. FIG. 10 illustrates an example of measurement results of the positive electrode voltage and the negative electrode voltage measured during charging and discharging by using the reference electrode of the solid-state battery as a reference and illustrates an example of the difference between the positive electrode voltage and the negative electrode voltage. FIG. 11 illustrates an example of a comparison result between the battery voltage of the solid-state battery and the difference between the positive electrode voltage and the negative electrode voltage during charging and discharging.

When the solid-state battery 1 including the reference electrode 80 using the reference electrode paste containing a positive electrode material was repeatedly charged and discharged in three cycles under the above conditions, the solid-state battery 1 exhibited the voltage behavior as illustrated in FIG. 9 as its battery voltage.

When this solid-state battery 1 was charged and discharged in three cycles, the positive electrode voltage measured by using the reference electrode 80 formed by using the reference electrode paste containing a positive electrode material as a reference exhibited the voltage behavior as illustrated by a thick solid line in FIG. 10. In addition, when this solid-state battery 1 was charged and discharged in three cycles, the negative electrode voltage measured by using the reference electrode 80 formed by using the reference electrode paste containing a positive electrode material as a reference exhibited the voltage behavior as illustrated by a thick dotted line in FIG. 10. FIG. 10 also illustrates, as a thin dotted line, the difference between the positive electrode voltage and the negative electrode voltage during charging and discharging, the voltages having been measured by using the reference electrode 80 formed by using the reference electrode paste containing a positive electrode material as a reference.

FIG. 11 illustrates a comparison result between the battery voltage (FIG. 9) of the solid-state battery 1 during charging and discharging, the solid-state battery 1 including the reference electrode 80 formed by using the reference electrode paste containing a positive electrode material, and the difference (FIG. 10) between the positive electrode voltage and the negative electrode voltage during charging and discharging, the voltages having been measured by using the reference electrode 80 as a reference. As illustrated in FIG. 11, a good conformity was observed between the battery voltage of the solid-state battery 1 during charging and discharging and the difference between the positive electrode voltage and the negative electrode voltage measured by using the reference electrode 80 as a reference.

Thus, it is fair to say that the reference electrode 80 formed by using the reference electrode paste containing a positive electrode material sufficiently functions as a reference for the voltages of the positive electrode 60 and the negative electrode 70 of the solid-state battery 1, that is, as a reference electrode.

### (Second Evaluation Example)

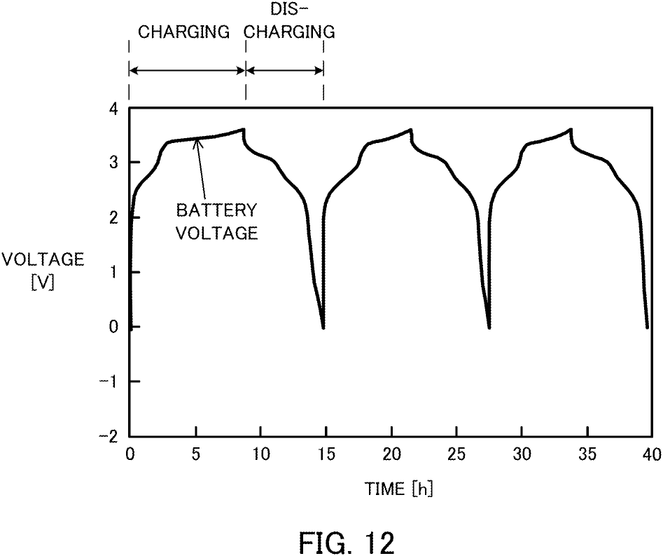

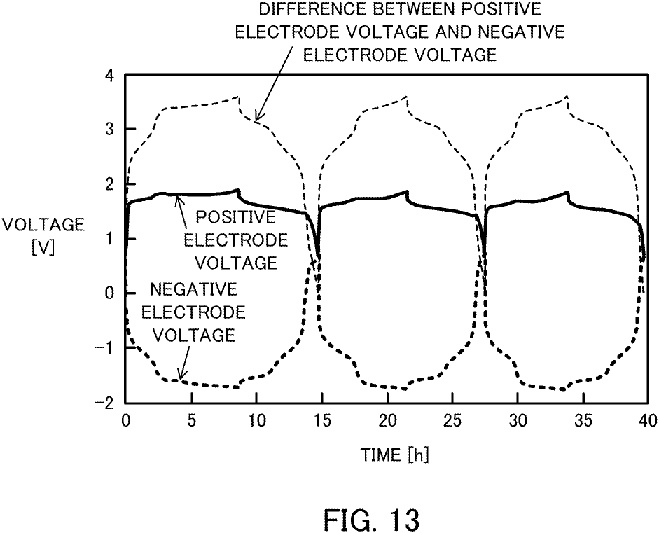

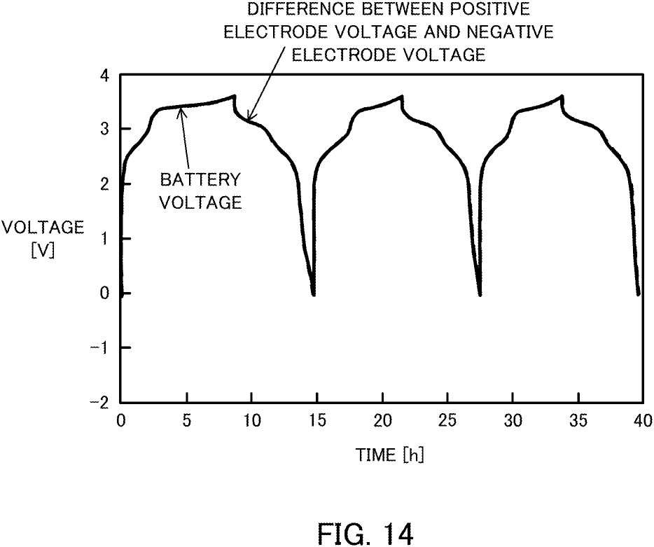

FIG. 12 illustrates an example of a measurement result of the battery voltage of a solid-state battery during charging and discharging. FIG. 13 illustrates an example of measurement results of the positive electrode voltage and the negative electrode voltage measured during charging and discharging by using the reference electrode of the solid-state battery as a reference and illustrates an example of the difference between the positive electrode voltage and the negative electrode voltage. FIG. 14 illustrates an example of a comparison result between the battery voltage of the solid-state battery and the difference between the positive electrode voltage and the negative electrode voltage during charging and discharging.

When the solid-state battery 1 including the reference electrode 80 using the reference electrode paste containing a carbon material was repeatedly charged and discharged in three cycles under the above conditions, the solid-state battery 1 exhibited the voltage behavior as illustrated in FIG. 12 as its battery voltage.

When this solid-state battery 1 was charged and discharged in three cycles, the positive electrode voltage measured by using the reference electrode 80 formed by using the reference electrode paste based containing a carbon material as a reference exhibited the voltage behavior as illustrated by a thick solid line in FIG. 13. In addition, when this solid-state battery 1 was charged and discharged in three cycles, the negative electrode voltage measured by using the reference electrode 80 formed by using the reference electrode paste containing a carbon material as a reference exhibited the voltage behavior as illustrated by a thick dotted line in FIG. 13. FIG. 13 also illustrates, as a thin dotted line, the difference between the positive electrode voltage and the negative electrode voltage during charging and discharging, the voltages having been measured by using the reference electrode 80 formed by using the reference electrode paste containing a carbon material as a reference.

FIG. 14 illustrates a comparison result between the battery voltage (FIG. 12) of the solid-state battery 1 during charging and discharging, the solid-state battery 1 including the reference electrode 80 formed by using the reference electrode paste containing a carbon material, and the difference (FIG. 13) between the positive electrode voltage and the negative electrode voltage during charging and discharging, the voltages having been measured by using the reference electrode 80 as a reference. As illustrated in FIG. 14, a good conformity was observed between the battery voltage of the solid-state battery 1 during charging and discharging and the difference between the positive electrode voltage and the negative electrode voltage measured by using the reference electrode 80 as a reference.

Thus, it is fair to say that the reference electrode 80 formed by using the reference electrode paste containing a carbon material sufficiently functions as a reference for the voltages of the positive electrode 60 and the negative electrode 70 of the solid-state battery 1, that is, as a reference electrode.

As described above, with the solid-state battery 1, it is possible to measure and monitor the voltage (the positive electrode voltage) of the positive electrode 60 connected to the positive electrode layers 10 and the voltage (the negative electrode voltage) of the negative electrode 70 connected to the negative electrode layers 20 by using, as a reference, the reference electrode 80 formed on the surface 50a of the battery body 50 in the direction in which the positive electrode layers 10, the electrolyte layers 30, and the negative electrode layers 20 are stacked. In this way, the voltages of the positive electrode 60 and the negative electrode 70 are accurately evaluated. By accurately evaluating the voltages of the positive electrode 60 and the negative electrode 70, the difference between the voltage of the positive electrode 60 and the voltage of the negative electrode 70, that is, the cause of deterioration or resistive change of the solid-state battery 1, which is not sufficiently determinable by the battery voltage alone, is accurately determined. Thus, the present technique will be useful, for example, in determining the cause of a defect of the solid-state battery 1 when the solid-state battery 1 is inspected, manufactured, or actually used, in addition to in developing the solid-state battery 1.

In addition, a marker indicating a polarity of the solid-state battery 1 may be configured to also function of the reference electrode 80 as described above. If the reference electrode 80 for accurately evaluating the voltage of each of the positive electrode 60 and the negative electrode 70 is formed in addition to a marker indicating a polarity of the solid-state battery 1, increase in size of the solid-state battery 1, increase in complexity of the manufacturing process, and increase in cost which may be caused. However, by having a marker also function as the reference electrode 80, the above increases are prevented.

The above description has been made based on an example in which the battery body 50 is formed by stacking the positive electrode layers 10 in two layers and the negative electrode layers 20 in two layers and by forming an electrolyte layer 30 between an individual positive electrode layer 10 and an individual negative electrode layer 20. However, the number of layers of the positive electrode layers 10, the negative electrode layers 20, and the electrolyte layers 30 formed therebetween is not limited to the above example. Positive electrode layers 10 in one layer and negative electrode layers 20 in one layer may be stacked and an electrolyte layer 30 may be formed between these two layers, to form a battery body. Alternatively, positive electrode layers 10 in three or more layers and negative electrode layers 20 in three or more layers may be stacked and an electrolyte layer 30 may be formed between an individual positive electrode layer 10 and an individual negative electrode layer 20, to form a battery body. Either way, a reference electrode 80 as described above may be formed on the surface in the direction in which these layers are stacked. In addition, it is possible to measure and monitor the positive electrode voltage and the negative electrode voltage by using the reference electrode 80 as a reference. It is also possible to use the reference electrode 80 as a marker that indicates a polarity of the solid-state battery.

In addition, the above description has been made based on an example in which the reference electrode 80 is formed by using reference electrode paste containing a positive electrode material or reference electrode paste containing a carbon material. However, the reference electrode 80 may be formed by using a different material. Various kinds of materials may be used for the reference electrode 80, as long as the reference electrode 80 having electrical conductivity is obtained.

For example, an apparatus on which the solid-state battery 1 is mounted may be provided with a mechanism that is connected to the reference electrode 80 and the positive electrode 60 and that measures the voltage of the positive electrode 60 by using the reference electrode 80 as a reference and a mechanism that is connected to the reference electrode 80 and the negative electrode 70 and that measures the voltage of the negative electrode 70 by using the reference electrode 80 as a reference. Alternatively, an apparatus on which the solid-state battery 1 is mounted may be configured without such mechanisms. In this case, when the solid-state battery 1 needs to be evaluated, the voltage of the positive electrode 60 and the voltage of the negative electrode 70 of the solid-state battery 1 mounted on or removed from the apparatus may be measured by using the reference electrode 80 as a reference.

In one aspect, it is possible to realize a solid-state battery including a positive electrode and a negative electrode whose voltages are accurately evaluated.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that various changes, substitutions, and alterations could be made hereto without departing from the spirit and scope of the disclosure.

What is claimed is:

1. A solid-state battery comprising:
a battery body in which a positive electrode layer, an electrolyte layer, and a negative electrode layer are stacked in a first direction;
a reference electrode stacked on a first surface of the battery body in the first direction;
a positive electrode provided on the battery body and connected to the positive electrode layer; and
a negative electrode provided on the battery body and connected to the negative electrode layer.

2. The solid-state battery according to claim 1,
wherein the positive electrode is provided on a first end face of the battery body in a second direction perpendicular to the first direction,
wherein the negative electrode is provided on a second end face of the battery body in the second direction, and
wherein the reference electrode is located closer to one of the first end face and the second end face than the other one of the first end face and the second end face on the first surface of the battery body.

3. The solid-state battery according to claim 1, wherein the reference electrode contains electrolyte and conductive auxiliary agent.

4. The solid-state battery according to claim 3,
wherein the positive electrode layer contains a positive electrode active material,
wherein the negative electrode layer contains a negative electrode active material, and
wherein the reference electrode contains the positive electrode active material or the negative electrode active material.

5. A solid-state battery manufacturing method comprising:
forming a multi-layer body in which a positive electrode layer, an electrolyte layer, and a negative electrode layer are stacked in a first direction;
stacking a reference electrode on a first surface of the multi-layer body in the first direction;
forming a positive electrode connected to the positive electrode layer on the multi-layer body; and
forming a negative electrode connected to the negative electrode layer on the multi-layer body.

6. The solid-state battery manufacturing method according to claim 5, further comprising integrally sintering the multi-layer body on which the reference electrode is stacked through a thermal process.

7. A solid-state battery monitoring method used when a solid-state battery including a battery body in which a positive electrode layer, an electrolyte layer, and a negative electrode layer are stacked in a first direction, a reference electrode stacked on a first surface of the battery body in the first direction, a positive electrode provided on the battery body and connected to the positive electrode layer, and a negative electrode provided on the battery body and connected to the negative electrode layer is charged or discharged, the solid-state battery monitoring method comprising:
measuring a voltage of the positive electrode by using the reference electrode as a reference; and
measuring a voltage of the negative electrode by using the reference electrode as a reference.
